(19) United States
(12) Patent Application Publication
(10) Pub. No.: US 2026/0201131 A1
(43) Pub. Date: Jul. 16, 2026

(54) MULTILAYER BARRIER FILM COATED POLYMERIC SUBSTRATE, ITS MANUFACTURE AND USE IN ELECTRONIC DEVICES

(71) Applicant: BASF COATINGS GMBH, Muenster (DE)

(72) Inventors: Edoardo MENOZZI, Kaisten (CH); Jan GEBERS, Basel (CH); Esteban RUCAVADO, Basel (CH); Alejandro Nicolás FILIPPIN, Winterthur (CH)

(21) Appl. No.: 19/136,016

(22) PCT Filed: Dec. 13, 2023
(86) PCT No.: PCT/EP2023/085547

§ 371 Date: Jun. 5, 2025

(30) Foreign Application Priority Data
Dec. 14, 2022 (EP) 22213523.8

(51) Int. Cl. C08J 5/18; C08J 7/04; C08J 7/043; C08J 7/048; C08J 7/12

(52) U.S. Cl. CPC C08J 5/18; C08J 7/0423; C08J 7/043; C08J 7/048; C08J 7/123; C08J 2333/10

(57) ABSTRACT

Disclosed herein is a multilayer barrier film coated polymeric substrate, the multilayer barrier film at least including a radiation-cured interlayer on top of the polymeric substrate, and one or more at least partially inorganic barrier layers on top of the interlayer, the interlayer being formed upon application and radiation-curing of a radiation-curable interlayer coating material on the polymeric substrate, where the radiation-curable interlayer coating material possesses a hydroxyl number in a range from 50 to 250 mg KOH/g. Further disclosed herein are a method for producing such multilayer barrier film coated polymeric substrate and a method of using the same.

The invention relates to a multilayer barrier film (MLBF) coated polymeric substrate, comprising an interlayer between the polymeric substrate and further layers. The invention further relates to a method to manufacture the MLBF coated substrate. Moreover, the invention relates to the use of the MLBF coated substrates in photovoltaic applications.

### BACKGROUND OF THE INVENTION

Polymeric films are widely used and useful in a broad range of industrial and consumer applications. Such films, for example, can be employed as transparent or tinted barrier films to protect different types of underlying substrates. Polymeric films, and particularly polymeric films made of semi-crystalline resins like for example polyester materials, offer many characteristics desirable in a barrier film. Among other properties, they should exhibit clarity, flexibility, impact and scratch resistance, hardness, durability, toughness, pliability, formability, light weight, and affordable costs.

Particularly, such films are used in electronic devices including opto-electronic devices. Electronic and opto-electronic devices, e.g., include electroluminescent (EL) display devices (particularly organic light emitting diodes, OLED devices), electrophoretic displays (e-paper) and flexible photovoltaic cells (CIGS, perovskite and or OPV).

The flexible polymeric film substrate and layers deposited thereon are typically transparent and they typically must meet stringent specifications for optical clarity, flatness and minimal birefringence. Typically, a total light transmission (TLT) of at least 85% over a range from 400 to 1100 nm coupled with a haze of less than 2% is desirable. Surface smoothness and flatness are necessary to ensure the integrity of subsequently applied layers. The multilayer film stack should also have good barrier properties, i.e., high resistance to gases, moisture, and solvents permeation.

Flexible polymeric substrates and coating layers allow the manufacture of electronic and opto-electronic devices in a roll-to-roll process, thereby reducing cost.

However, disadvantages of polymeric films often include lower chemical resistance, inferior barrier properties and inferior dimensional stability, relative to optical-quality glass or quartz. Inorganic as well as organic barrier coatings have been developed to minimize this problem, and typically these are applied in a sputtering process at elevated temperatures. U.S. Pat. No. 6,198,217 discloses materials suitable as barrier layers. WO 2003/022575 A1 discloses flexible polymeric films which exhibit good high-temperature dimensional stability at elevated-temperature processing conditions experienced during the manufacture of backplanes and display devices, including deposition of a barrier layer onto a polymeric substrate.

However, use of some of the most desirable polymeric films can be severely limited when a submicrometric defect free transparent barrier layer needs to be directly deposited on them.

In WO 2022/233992 A1 a multilayer barrier film is described, which comprises an inorganic barrier layer deposited on a transparent polymeric polyester film and proposes to use an optional UV curable planarization layer between the polyester film and the inorganic barrier. Such planarization layer is suggested in WO 2022/233992 A1, particularly for those cases where substrate films with high planarity are not available, e.g., due to small scratches, or particles such as dust adhered to their surface. Thus, the main aim of a planarization layer is to avoid damaging such as puncturing the multilayer barrier film. However, WO 2022/233992 A1 also mentions that the planarization layer can additionally serve to better hold together the polymeric substrate film and the MLBF, particularly upon bending or heating, but without providing a specific suggestion how to obtain such function. WO 2022/233992 A1 rather refers to formulations of other UV-curable compositions used in this document, which however rather aim to have a good adhesion to a top coat layer, particularly those top coat layers containing fluoro-polymers.

Thus, there is still a need for an MLBF coated substrate comprising an improved interlayer between the polymeric substrate and the inorganic barrier layer, the interlayer having a good adhesion to the substrate as well as to the inorganic barrier layer and serving as a planarization layer. Furthermore, the dynamic mechanical properties of such MLFB coated substrate should be excellent the interlayer coating material used to produce such interlayer should have a viscosity in a suitable range.

### SUMMARY

The above aims of the present invention were achieved by providing a multilayer barrier film (MLBF) coated polymeric substrate (A), the multilayer barrier film at least comprising
a radiation-cured interlayer (I) on top of the polymeric substrate (A) and one or more at least partially inorganic barrier layers (B) on top of the interlayer (I),
the interlayer (I) being formed upon application and radiation-curing of a radiation-curable interlayer coating material (ICM) on the polymeric substrate, the radiation-curable interlayer coating material (ICM) possessing a hydroxyl number in the range from 50 to 250 mg KOH/g.

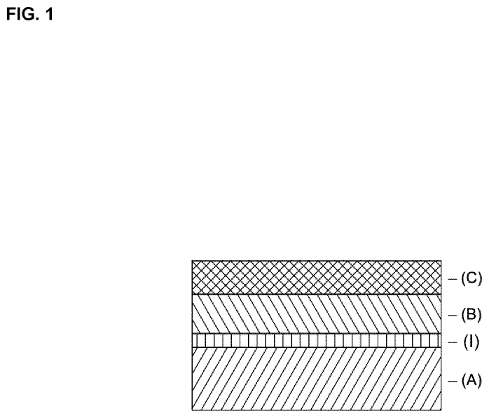

FIG. 1 shows a typical architecture of an MLBF on a substrate (A) according to the invention, the MLBF comprising in this order the interlayer (I), an at least partially inorganic barrier layer (B), and an optional topcoat layer (C).

Thus, in the MLBF on a substrate (A) as claimed according to the invention there is direct contact between the substate (A) and interlayer (I), and interlayer (I) and the at least partially inorganic barrier layer (B), respectively.

The term “at least partially inorganic” in view of the “at least partially inorganic barrier layer (B)” means that the inorganic barrier layer (B) itself can consist of one or more inorganic layers, i.e., layers which are completely composed of inorganic material. In the alternative, “a partially inorganic barrier layer (B)” consist of at least one inorganic layer and at least one organic layer, preferably in an alternating order, thus the complete layer (B) consisting of inorganic layers and organic layers is being understood as “partially inorganic” in such case.

The term “radiation-cured” in view of the radiation-cured interlayer (I) refers to the radiation-curable nature of the crosslinkable monomers, oligomers and polymers being used to produce the radiation-cured interlayer (I).

In the following, the claimed MLBF coated substrate is also denoted as the “multilayer barrier film coated substrate of the invention” or the “MLBF coated substrate of the invention.”

Yet another object of the present invention is a method for producing a multilayer barrier film coated polymeric substrate (A) comprising the steps of
a. providing a polymeric substrate (A);
b. applying a radiation-curable interlayer coating material (ICM) as defined above for the MLBF coated substrate of the invention and curing the radiation-curable interlayer coating material (ICM) to form a radiation cured interlayer (I)
c. depositing one or more inorganic layers on the substrate by one or more methods selected from chemical vapor deposition (CVD), physical vapor deposition (PVD), atomic layer deposition (ALD) and sputtering to form one or more at least partially inorganic barrier layers (B).

In the following the method for producing a multilayer barrier film coated substrate is also denoted as the “method for producing a multilayer barrier film coated substrate according to the invention” or the “method for producing an MLBF coated substrate according to the invention.”

Yet another object of the present invention is the use of MLBF coated substrate of the invention or the MLBF coated substrate of the invention in electronic devices including opto-electronic devices.

In the following the use of MLBF of the invention or the MLBF coated substrate of the invention used in electronic devices including opto-electronic devices is also denoted as the “use of the invention.”

Further preferred features and embodiments of the invention are disclosed in the dependent claims and the following detailed description.

### DETAILED DESCRIPTION

### Multilayer Barrier Film Coated Substrate

In the following, different types of substrates are disclosed which can be coated by the multilayer barrier film. Subsequently, the formation of the interlayer (I) and the at least partially inorganic barrier layer (B) are described in more detail.

Preferably the polymeric substrate (A), as well as all subsequent layers are transparent. The term “transparent” as used herein-below in view of the layers and the substrate means that the layers and/or substrate are translucent, i.e., light-transmissive. The term “transparent” as used herein can be quantified by determination of the total luminous transmittance according to ASTM D 1003:2013. Preferably, the thus determined total luminous transmittance of each layer of the MLBF, the MLBF itself and the herein below described MLBF-coated substrate is in the range from 80% to 99%, more preferred in the range from 85% to 98% and most preferred in the range from 90% to 97%.

### Substrates

As substrates any polymeric substrates can be used.

Suitable polymers include polyesters such as polyethylene terephthalate (PET), polybutylene terephthalate and polyethylene naphthalene-dicarboxylic acid (PEN); polyimides; polyacrylates such as polymethyl methacrylate (PMMA); polyacrylamides;

polycarbonates such as poly(bisphenol A carbonate); polyvinylalcohol and its derivatives like polyvinyl acetate or polyvinyl butyral; polyvinylchloride; polyolefins, which include polycycloolefins, such as polyethylene (PE), low density polyethylene (LDPE), linear low density polyethylene (LLDPE), high density polyethylene (HDPE), polypropylene (PP) and polynorbornene; polysulfones, such as polysulfone (PSU), polyethersulfone (PES) and polyphenylene sulfone (PPSU); polyamides like polycaprolactam (PA6) or poly(hexamethylene adipic amide) (Nylon 66); cellulose derivatives such as hydroxyethyl cellulose, hydroxypropyl cellulose, methyl cellulose, methyl hydroxylpropyl cellulose or nitrocellulose; polyurethanes; epoxy resins; melamine formaldehyde resins; phenol formaldehyde resins. The term “polymers” includes copolymers made of two or more different kinds of monomers, such as poly(ethylene-co-norbornene) or poly(ethylene-co-vinylacetate).

Amongst the afore-mentioned polymers, transparent polymers from the group consisting of polyesters, polyolefins, polyamides and polysulfones are preferred; and polyesters such as PET are most preferred.

Preferably, the polymeric substrates, should be stable to heat of at least 140° C.

The substrates can have any size and shape. Preferably the substrates, most preferred the polymeric substrates, are in form of a transparent polymeric substate film. Preferred film thicknesses are in the range from 10 to 500 μm, more preferred in the range from 25 to 300 μm, and even more preferred in the range from 50 to 150 μm.

### Interlayer (I)

As stated above, the term “radiation-cured” in view of the radiation-cured interlayer (I) refers to the radiation-curable nature of crosslinkable species selected from monomers, oligomers and polymers being used to produce this layer.

Preferably the radiation-curable monomers, oligomers, and polymers, contain at least one, preferably two or more radiation-curable groups such as (meth)acrylic groups, vinyl groups and/or allyl groups, (meth)acrylic groups being most preferred and are even more preferred the only radiation-curable groups in the radiation-curable monomers, oligomers, and polymers comprised in the radiation-curable interlayer coating material (ICM) used to prepare the radiation-cured interlayer (I).

It is most preferred that the radiation-cured interlayer (I) is a (meth)acrylate layer, i.e., the presence of (meth)acrylic groups on at least some of the monomers, oligomers, and polymers before curing, i.e., crosslinking, which react with each other to form the radiation-cured (meth)acrylate layer, is mandatory. The term “(meth)acrylate” denotes for both “acrylate” and “methacrylate.” The same applies for the use of terms “(meth)acryl” and “(meth)acrylic.”

Thus, radiation curing is typically achieved by actinic radiation, such as electron beam (EB) or UV radiation. Curing by UV-radiation is particularly preferred.

Therefore, the radiation-cured interlayer (I) is preferably based on a UV-cured solvent-free (meth)acrylic system. The term “solvent-free” means free of non-reactive solvent, since reactive diluents are not excluded by this term.

The interlayer (I) serves to provide good compatibility to many polymeric films (A), but also to the at least partially inorganic layer (B). However, polymeric films (A) are often not available with highest planarity, e.g., due to small scratches, or particles such as dust adhered to their surface. It is therefore preferred, that the interlayer (I) also serves as a planarization layer.

As a requirement of the present invention, the interlayer coating material (ICM) must possess a hydroxyl number in the range from 50 to 250 mg KOH/g, preferably from 55 to 250 mg KOH/g and even more preferred from 60 to 230 mg KOH/g, determined as detailed in the experimental part of the description. Thus, the cured interlayer (I) will also possess hydroxyl groups, some of which will be at the interlayer (I)-air interface. It has been found by the inventors that the hydroxyl number has a positive influence on the adhesion of the subsequently deposited at least partially inorganic barrier layer (B). To introduce such hydroxy functionalities into the ICM and thus the cured interlayer (I), the ICM needs to contain hydroxy functional radiation-curable ingredients, such as radiation-curable oligomeric (meth)acrylate functional species and/or radiation-curable (meth)acrylate functional monomers, as will be described below in more detail.

Preferably, the interlayer coating material (ICM) used to produce the interlayer (I) has a viscosity at 25° C. determined before curing in the range from 80 to 250 mPas, more preferably from 90 to 220 mPas and most preferably from 100 to 200 mPas. Details on how to determine the viscosity are found in the experimental part of the description.

Preferably, the interlayer coating material (ICM) used to produce the interlayer (I) has a viscosity at 50° C. determined before curing in the range from 20 to 80 mPas, more preferably from 25 to 60 mPas and most preferably from 25 to 50 mPas. Details on how to determine the viscosity are found in the experimental part of the description.

While the cured interlayers (I) as produced from the interlayer coating material (ICM) should be flexible, they still should have a glass transition temperature, determined as detailed in the experimental part of the description, in the range from preferably 60 to 150° C., more preferred from 70 to 145° C. and most preferred in the range from 80 to 145° C.

The storage modulus of the interlayer (I) at 20° C. is preferable at least 1000 MPa up to preferably 3000 mPa, more preferred at least 1200 MPa up to 2500 MPa, or even more preferred at least 1500 MPa up to 2200 MPa, determined as detailed in the experimental part of the description.

In the following a preferred ingredients for an interlayer coating material (ICM) are shown. Species used to form the interlayer coating material (ICM) and thereof the interlayer (I) preferably comprise
i. one or more radiation-curable oligomeric (meth)acrylate-functional species;
ii. one or more radiation curable (meth)acrylate-functional monomers;
iii. optionally one or more adhesion promoters;
iv. in case of UV-curing, one or more photoinitiators;
v. one or more compounds selected from UV absorbers and light stabilizers; and
vi. optionally one or more coatings additives.

### Radiation-Curable Oligomeric (Meth)Acrylate-Functional Species i.

The one or more radiation-curable oligomeric (meth)acrylate-functional species are preferably selected from the group consisting of polyester (meth)acrylates, epoxy (meth)acrylates, aliphatic and/or aromatic urethane (meth)acrylates, preferably aliphatic urethane (meth)acrylates, polyether (meth)acrylates and (meth)acrylated poly(meth)acrylates, amongst which the urethane (meth)acrylates, particularly the aliphatic urethane acrylates, and (meth)acrylated poly(meth)acrylates are preferred.

Polyester (meth)acrylates typically have a lower viscosity compared to the other oligomers, while epoxy(meth)acrylates have an increased reactivity and the coatings obtained by their use show a good hardness and chemical resistance.

(Meth)acrylated poly(meth)acrylates help to provide a good adhesion. Preferably the (meth)acrylated poly(meth)acrylates have an acid number being in the range from 0 to 10 mg KOH/g, more preferred 0 to 5 mg KOH/g and most preferred 0 to 2 mg KOH/g and/or a hydroxyl number being in the range from 0 to 10 mg KOH/g, more preferred 0 to 5 mg KOH/g and most preferred 0 to 2 mg KOH/g.

Aromatic urethane (meth)acrylates provide an increased flexibility, elongation and toughness, a good hardness and chemical resistance to the coatings obtained therewith and multifunctional aromatic urethane (meth)acrylates show an increased reactivity. However, aliphatic urethane (meth)acrylates are preferred, because they show the same good characteristics as the aromatic urethane (meth)acrylates, but tend less to undesired yellowing. Preferably the aliphatic urethane (meth)acrylates have a (meth)acrylate functionality in the range from 2 to 4 and/or a hydroxyl number in the range from 1 to 20 mg KOH/g, more preferred from 2 to 10 mg KOH/g, and even more preferred from 2 to 8 mg KOH/g.

The afore-mentioned radiation-curable oligomeric (meth)acrylate-functional species preferably contain functional groups selected from the group consisting of OH groups and COOH groups. Most preferred the urethane (meth)acrylates comprise OH groups while the (meth)acrylated poly(meth)acrylates comprise COOH groups and/or OH groups, preferably at least COOH groups.

The total amount of the one or more radiation-curable oligomeric (meth)acrylate-functional species i. preferably ranges from 1 wt.-% to 35 wt.-% most preferably from 3 wt.-% to 30 wt.-% and even more preferred from 5 wt.-% to 25 wt.-% based on the total combined weight of the radiation-curable oligomeric (meth)acrylate-functional species i. and the radiation-curable (meth)acrylate-functional Monomers ii.

The total amount of the one or more radiation-curable oligomeric (meth)acrylate-functional species i. preferably ranges from 1 wt.-% to 30 wt.-% more preferably from 3 wt.-% to 25 wt.-% and even more preferred from 3 wt.-% to 20 wt.-% based on the interlayer coating material (ICM).

### Radiation-Curable (Meth)Acrylate-Functional Monomers ii.

The one or more radiation curable (meth)acrylate-functional monomers are those known to one of skill in the art of radiation-curable compositions. Such radiation curable (meth)acrylate-functional monomers possess low viscosities. They are often used to dilute the radiation-curable oligomeric (meth)acrylate-functional species and are thus also known as radiation-curable reactive diluents, since they act as solvents, but remain in the cured coating after curing. Such monomers may, in some cases, contain dialkyleneglycol or trialkyleneglycol groups, but are still considered herein as monomers due to their definite molecular weight.

The one or more (meth)acrylate-functional monomers preferably comprise mono(meth)acrylate functional monomers, di(meth)acrylate functional monomers and less preferred tri- and/or tetra(meth)acrylate functional monomers, while even higher functionalities are not excluded, but are even less preferred.

Amongst the one or more (meth)acrylate-functional monomers the mono(meth)acrylate functional monomers and di(meth)acrylate functional monomers are most preferred.

To achieve the desired hydroxyl numbers in the interlayer coating material (ICM) it is typically not sufficient if the radiation-curable oligomeric (meth)acrylate-functional species contains hydroxyl groups. Therefore, it is typically necessary to employ one or more (meth)acrylate-functional monomers, having additionally one or more hydroxyl groups, to achieve the required hydroxyl numbers of the ICM.

The total amount of the one or more radiation-curable (meth)acrylate-functional monomers ii., which contain one or more hydroxyl preferably ranges preferably from 18 wt.-% to 95 wt.-% most preferably from 20 wt.-% to 95 wt.-% based on the total weight of the interlayer coating material (ICM). Of course, it is selected to comply with the required hydroxyl number as set out herein-above.

Preferred (meth)acrylate-functional monomers, having additionally one or more hydroxyl groups, are the mono(meth)acrylates and di(meth)arylates of glycerol, trimethylol propane and trimethylol ethane; and the mono(meth)acrylates, di(meth)acylates and tri(meth)acrylates of pentaerythritol, ditrimethylolpropane, and ditrimethylolethane. However, it is also possible to use alpha, omegy-alkanediylbis[oxy(2-hydroxy-3,1-propanediyl)]di(meth)acrylate, such as 1,2-ethanediylbis[oxy(2-hydroxy-3,1-propanediyl)]di(meth)acrylate, 1,3-propanediylbis[oxy(2-hydroxy-3,1-propanediyl)]di(meth)acrylate, and 1,4-butanediylbis[oxy(2-hydroxy-3,1-propanediyl)]di(meth)acrylate.

Amongst the afore-mentioned (meth)acrylate-functional monomers, having additionally one or more hydroxyl groups, the di(meth)acrylate-functional monomers, having additionally one or two hydroxyl groups are even more preferred.

Most preferred di(meth)acrylate-functional monomer, having additionally one hydroxyl group is glycerol di(meth)acrylate. Most preferred di(meth)acrylate-functional monomers, having additionally two hydroxyl groups is 1,4-butanediylbis[oxy(2-hydroxy-3,1-propanediyl)]di(meth)acrylate.

Besides the (meth)acrylate-functional monomers, having additionally one or more hydroxyl groups, further (meth)acrylate-functional monomers are typically contained in the interlayer coating materials (ICM) as used in the present invention. Such (meth)acrylate-functional monomers preferably contain, besides the (meth)acrylic group only hydrocarbon groups or ether oxygen containing hydrocarbon groups. Examples of such (meth)acrylate-functional monomers are described below.

Examples of mono(meth)acrylate functional monomers include hydrocarbylesters of (meth)acrylic acid, wherein the hydrocarbyl residues can be aliphatic or aromatic and linear, branched, or cyclic, preferably the hydrocarbyl groups containing 4 to 20, more preferably 6 to 18 carbon atoms. Specific examples e.g., alkyl(meth)acrylates, such as cyclohexyl(meth)acrylate, hexyl(meth)acrylate, 2-ethylhexyl(meth)acrylate, tert-octyl(meth)acrylate, decyl(meth)acrylate, isodecyl(meth)acrylate, lauryl(meth)acrylate, stearyl(meth)acrylate, isostearyl(meth)acrylate, 4-n-butylcyclohexyl(meth)acrylate; bornyl(meth)acrylate; isobornyl(meth)acrylate; tricyclodecanemethanol(meth)acrylate, e.g., aralkyl(meth)acrylates, such as benzyl(meth)acrylate; e.g., aryl(meth)acrylates such as 4-butylphenyl(meth)acrylate, phenyl (meth)acrylate and 2,3,4,5-tetramethylphenyl (meth)acrylate. Further examples of mono(meth)acrylate functional monomers include ether oxygen containing hydrocarbylesters of (meth)acrylic acid, wherein the ether oxygen containing hydrocarbyl residues can be aliphatic or aromatic and linear, branched, or cyclic, preferably the ether oxygen containing hydrocarbyl groups contain 4 to 20, more preferably 6 to 18 carbon atoms. Specific examples are e.g., alkoxyalkyl(meth)acrylates, such as, butoxyethyl(meth)acrylate, butoxymethyl(meth)acrylate, 3-methoxybutyl(meth)acrylate; aryloxyalkyl(meth)acrylates, such as phenoxymethyl (meth)acrylate and phenoxyethyl(meth)acrylate; 2-ethylhexyl diglycol (meth)acrylate, 2-(2-methoxyethoxy)ethyl(meth)acrylate, 2-(2-butoxyethoxy)ethyl(meth)acrylate; and trimethylolpropanformal (meth)acrylate.

Amongst the afore-mentioned mono(meth)acrylate functional monomers those being cyclic hydrocarbonesters of (meth)acrylic acid and those being cyclic ether oxygen containing hydrocarbonesters of (meth)acrylic acid are most preferred. Particularly preferred are, e.g., isobornyl(meth)acrylate, tricyclodecanemethanol (meth)acrylate and trimethylolpropanformal (meth)acrylate.

Examples of di(meth)acrylate functional monomers are alkanediol di(meth)acrylates, wherein the alkanediol preferably contains 3 to 16, more preferred 4 to 14 carbon atoms. Specific examples are 1,3-propanediol di(meth)acrylate, 1,3-butanediol di(meth)acrylate, 1,4-butanediol di(meth)acrylate, 1,5-pentanediol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, 1,12-dodecanediol di(meth)acrylate and 1,14-tetradecanediol di(meth)acrylate. Further examples of di(meth)acrylate functional monomers are dialkyleneglycol di(meth)acrylates, such as diethyleneglycol di(meth)acrylate and dipropyleneglycol di(meth)acrylate; trialkyleneglycol (meth)acrylates, such triethyleneglycol di(meth)acrylate and tripropyleneglycol di(meth)acrylate; and neopentylglycol-propoxy di(meth)acrylate.

Less preferred are the tri- and tetra(meth)acrylate functional monomers. The higher the functionality, the less preferred are the monomers in the present invention. Specific examples of tri(meth)acrylate functional monomers include trimethylolpropane tri(meth)acrylate, trimethylolethane tri(meth)acrylate or glycerol tri(meth)acrylate, A specific example of a tetra(meth)acrylate-functional monomers is pentaerythritol tetra(meth)acrylate.

Preferably, the radiation-curable compositions of the present invention comprise from the groups of radiation curable (meth)acrylate-functional monomers ii. only mono(meth)acrylic monomers and di(meth)acrylic monomers.

The total amount of the one or more radiation-curable (meth)acrylate-functional monomers ii. preferably ranges from 65 wt.-% to 99 wt.-% most preferably from 70 wt.-% to 97 wt.-% and even more preferred from 75 wt.-% to 95 wt.-% based on the total combined weight of the radiation-curable oligomeric (meth)acrylate-functional species i. and the radiation-curable (meth)acrylate-functional monomers ii.

The total amount of the one or more radiation-curable (meth)acrylate-functional monomers ii. preferably ranges from 65 wt.-% to 95 wt.-% more preferably from 65 wt.-% to 92 wt.-% and even more preferred from 70 wt.-% to 92 wt.-% based on the interlayer coating material (ICM).

### Adhesion Promoters iii.

If adhesion promoters are present, the one or more adhesion promoters are preferably selected from the group consisting of functionalized trialkoxysilanes and functionalized dialkoxyalkylsilanes, preferably functionalized trialkoxysilanes, such as functionalized trimethoxysilanes, the functional groups preferably being selected from thiol groups, (meth)acryl groups, amino groups and epoxy groups; and (meth)acrylated phosphoric acid esters. Although some of the afore-mentioned adhesion promoters iii. have (meth)acrylate groups and are monomeric, they are not included in the amounts of radiation-curable (meth)acrylate-functional monomers ii.

The total amount of the one or more adhesion promoters iii. preferably ranges from 0 wt.-% to 10 wt.-% more preferably from 1 wt.-% to 8 wt.-% and most preferred from 2 wt.-% to 7 wt.-% based on the total weight of the radiation-curable interlayer coating material (ICM).

### Photoinitiators iv.

In case of UV-curing one or more photoinitiators, preferably selected from the group consisting of alpha-cleaving photoinitiators, such as alpha-hydroxyketones (e.g., benzoin, acetophenones), alpha-alkoxyketones (e.g., benzoinethers, benzilketales), alpha-aminoketones and acyl phosphine oxides are contained.

The photoinitiators can be subsumed under the terms “surface curing types”, such as alpha-alkoxyketones and “bulk curing types”, such as acyl phosphine oxides. If both are present, it is preferred that the photoinitiator weight ratio between surface curing types and bulk curing types ranges from 1:4 to 1:1.

The total amount of the one or more photoinitiators iv., if contained, preferably ranges from 0.5 wt.-% to 6 wt.-% most preferably from 1 wt.-% to 5 wt.-% and even more preferred from 2 wt.-% to 4 wt.-% based on the total weight of the radiation-curable interlayer coating material (ICM).

### UV Absorbers, Light Stabilizers v.

The UV absorbers are preferably selected from the group consisting of 2-(2′-hydroxyphenyl)benzotriazoles, 2-hydroxybenzophenones, esters of substituted and unsubstituted benzoic acids, acrylates like ethyl alpha-cyano-beta,beta-diphenylacrylates, 2-(2-hydroxyphenyl)-1,3,5-triazines and oxamides.

The total amount of the one or more UV absorbers v. preferably ranges from 0 wt.-% to 8 wt.-%, more preferred from 1 to 6 wt.-%, and most preferred 2 to 5 wt.-% based on the total weight of the radiation-curable interlayer coating material (ICM).

The light stabilizers v. are preferably hindered amine light stabilizers (HALS) including NOR-HALS. The NOR-HALS is a sub class of HALS also called Aminoxyl radical hindered amine light stabilizers. While HALS act as a base and become neutralized by acid for example, NOR-HALS, are not a strong base and are not deactivated by hydrochloric acid.

The total amount of the one or more light stabilizers v. preferably ranges from 0 wt.-% to 5 wt.-%, more preferred from 0.5 to 4 wt.-% and most preferred from 0.8 to 3 wt.-% based on the total weight of the radiation-curable interlayer coating material (ICM).

### Coatings Additives vi.

The radiation-curable interlayer coating material (ICM) may contain typical coatings additives, such as levelling agent, defoamers, preferably, but not necessarily are reactive in radiation-curing.

The amount of coating additives is preferably in the range from 0 to 5 wt.-%, more preferred 0 to 3 wt.-% and most preferred 0 to 2 wt.-% based on the total weight of the radiation-curable interlayer coating material (ICM).

### Particularly Preferred Embodiments of the Interlayer Coating Material (ICM)

### The Interlayer Coating Material (ICM) Preferably Comprise

i. one or more radiation-curable oligomeric (meth)acrylate-functional species selected from the group consisting of polyester (meth)acrylates, epoxy (meth)acrylates, aliphatic and/or aromatic urethane (meth)acrylates, preferably aliphatic urethane (meth)acrylates, polyether (meth)acrylates and (meth)acrylated poly(meth)acrylates;
ii. one or more radiation curable (meth)acrylate-functional monomers selected from the group consisting of mono(meth)acrylate-functional monomers and di(meth)acrylate-functional monomers and tri(meth)acrylate-functional monomers, at least part of the (meth)acrylate-functional monomers having one or more hydroxyl groups;
iii. optionally one or more adhesion promoters selected from the group consisting of functionalized trialkoxysilanes and functionalized dialkoxyalkylsilanes, being functionalized with a group selected from thiol groups, (meth)acryl groups, amino groups and epoxy groups; and (meth)acrylated phosphoric acid esters;
iv. one or more photoinitiators;
v. one or more compounds selected from UV absorbers and/or light stabilizers, the one or more light stabilizers preferably being selected from the group consisting of hindered amine light stabilizers including NOR-HALS; and
vi. optionally one or more coatings additives.

### Even More Preferred the Interlayer Coating Material (ICM) Comprise

i. one or more radiation-curable oligomeric (meth)acrylate-functional species selected from the group consisting of aliphatic and/or aromatic urethane (meth)acrylates, and (meth)acrylated poly(meth)acrylates;
ii. one or more radiation curable mono(meth)acrylate-functional monomers and one or more di(meth)acrylate-functional, hydroxyl group containing monomers;
iii. optionally one or more adhesion promoters selected from the group consisting of (meth)acrylic trialkoxysilanes (meth)acrylic dialkoxyalkylsilanes; and (meth)acrylated phosphoric acid esters;
iv. one or more photoinitiators selected from the group consisting of alpha-cleaving photoinitiators, such as alpha-hydroxyketones, alpha-alkoxyketones, alpha-aminoketones and acyl phosphine oxides;
v. one or more compounds selected from UV absorbers selected from the group consisting of 2-(2′-hydroxyphenyl)benzotriazoles, 2-hydroxybenzophenones, esters of substituted and unsubstituted benzoic acids, acrylates like ethyl alpha-cyano-beta, beta-diphenylacrylates, 2-(2-hydroxyphenyl)-1,3,5-triazines and oxamides, and/or one or more light stabilizers selected from the group consisting of hindered amine light stabilizers including NOR-HALS; and
vi. optionally one or more coatings additives.

### Most Preferred the Interlayer Coating Material (ICM) Comprise

i. one or more radiation-curable oligomeric (meth)acrylate-functional species selected from the group consisting of aliphatic urethane (meth)acrylates, and (meth)acrylated poly(meth)acrylates;
ii. one or more radiation curable mono(meth)acrylate-functional monomers, preferably selected from cyclic hydrocarbyl esters of (meth)acrylic acid and ether oxygen containing cyclic hydrocarbyl esters of (meth)acrylic acid; and one or more di(meth)acrylate-functional, hydroxyl group containing monomers;
iii. optionally one or more adhesion promoters selected from the group consisting of (meth)acrylic trialkoxysilanes (meth)acrylic dialkoxyalkylsilanes; and (meth)acrylated phosphoric acid esters;
iv. one or more photoinitiators selected from the group consisting of alpha-cleaving photoinitiators, such as alpha-hydroxyketones, alpha-alkoxyketones, alpha-aminoketones and acyl phosphine oxides;
v. one or more compounds selected from UV absorbers selected from the group consisting of 2-(2′-hydroxyphenyl)benzotriazoles, 2-hydroxybenzophenones, esters of substituted and unsubstituted benzoic acids, acrylates like ethyl alpha-cyano-beta,beta-diphenylacrylates, 2-(2-hydroxyphenyl)-1,3,5-triazines and oxamides, and/or one or more light stabilizers selected from the group consisting of hindered amine light stabilizers including NOR-HALS; and
vi. optionally one or more coatings additives.

In any of the afore-mentioned embodiments, but also generally, the (meth)acrylate-functional monomers, having additionally one or more hydroxyl groups, are the mono(meth)acrylates and di(meth)arylates of glycerol, trimethylol propane and trimethylol ethane; and the mono(meth)acrylates, di(meth)acylates and tri(meth)acrylates of pentaerythritol, ditrimethylolpropane, and ditrimethylolethane. However, it is also possible to use alpha, omegy-alkanediylbis[oxy(2-hydroxy-3,1-propanediyl)]di(meth)acrylate, such as 1,2-ethanediylbis[oxy(2-hydroxy-3,1-propanediyl)]di(meth)acrylate, 1,3-propanediylbis[oxy(2-hydroxy-3,1-propanediyl)]di(meth)acrylate, and 1,4-butanediylbis[oxy(2-hydroxy-3,1-propanediyl)]di(meth)acrylate.

Even more preferred amongst the afore-mentioned monomers are the di(meth)arylates of glycerol, trimethylol propane and trimethylol ethane, pentaerythritol, ditrimethylolpropane, ditrimethylolethane and 1,4-butanediylbis[oxy(2-hydroxy-3,1-propanediyl)]di(meth)acrylate.

Most preferred are glycerol di(meth)acrylate and 1,4-butanediylbis[oxy(2-hydroxy-3,1-propanediyl)]di(meth)acrylate, whereunder glycerol di(meth)acrylate is even more preferred.

### Preferred Ranges of Ingredients

Preferably the amounts of the above ingredients i. to vi. in the interlayer coating material (ICM) are in the following ranges
i. 1 to 30 wt.-%, more preferred 3 to 25 wt.-%, most preferred 3 to 20 wt.-%;
ii. 65 to 95 wt.-%, more preferred 65 to 92 wt.-%, most preferred 70 to 92 wt.-%,
iii. 0 to 10 wt.-%, more preferred 1 to 8 wt.-%, most preferred 2 to 7 wt.-%,
iv. 0.5 to 6 wt.-%, more preferred 1 to 5 wt.-%, most preferred 2 to 4 wt.-%,
v. 0 to 8 wt.-%, more preferred 1 to 6 wt.-%, most preferred 2 to 5 wt.-% for UV absorbers, and 0 to 6 wt.-%, more preferred 0.5 to 4 wt.-%, most preferred 0.8 to 3 wt.-% for light stabilizers,
vi. 0 to 5 wt.-%, more preferred 0 to 3 wt.-%, most preferred 0 to 2 wt-%.

All ingredient comprised in the interlayer coating material (ICM) summing up to 100 wt.-%

It is allowed to combine ranges of one or more ingredient with any ranges of the other ingredients, if the sum of ingredients does not exceed 100 wt.-%.

More preferred the preferred ranges of i., ii. and iv. are combined, the more preferred ranges of i., ii. and iv. are combined, or the most preferred ranges of i., ii. and iv. are combined. Any of the afore-mentioned combined ranges can be combined independently with the preferred, more preferred, or most preferred ranges of ingredients iii., v. and vi.

Most preferred all preferred ranges are combined, all more preferred ranges are combined, or all most preferred ranges are combined.

Thickness of the Radiation-Cured Interlayer (I) Formed from the Radiation-Curable Interlayer Coating Material (ICM)

The final thickness of the radiation-cured interlayer (I) preferably ranges from 1 to 20 μm, more preferred from 2 to 15 μm and most preferred from 4 to 10 μm. When the layer thickness is in the above ranges, a crack-free and pinhole-free coating after deposition of the at least partially inorganic barrier layer is facilitated, and it is still possible to roll the final film without damaging the at least partially inorganic barrier layer.

### At Least Partially Inorganic Barrier Layer (B)

The at least partially inorganic barrier layer(s) (B) are preferably transparent and serve to provide a good moisture barrier property to the MLBF. The water vapor transmission rate (WVTR) at 60° C. and 90% relative humidity should preferably be lower than 5×10⁻³ g/m²/day.

As defined above, the term “at least partially inorganic” in view of the “at least partially inorganic barrier layer (B)” means that the inorganic barrier layer (B) itself can consist of one or more inorganic layers, i.e., layers which are completely composed of inorganic material, thus it is an “inorganic barrier layer (B).” In the alternative, “a partially inorganic barrier layer (B)” consist of at least one inorganic layer and at least one organic layer, preferably in an alternating order, thus the complete layer (B) consisting of inorganic layers and organic layers is being understood as “partially inorganic” in such case.

In case layer (B) consists of one or more inorganic layers, layer (B) is denoted in the following as (Bⁱ)ₘ, wherein “i” stands for “inorganic” and m for the number of layers. Preferably m being from 1 to 2000, more preferred m=10 to 1000 and most preferred m=20 to 500.

In case layer (B) further contains one or more organic layers beside the one or more inorganic layers, layer (B) is denoted in the following as (BⁱB^{o})ₙ(Bⁱ)ₜ, wherein “i” stands for “inorganic”, “o” stands for “organic”; n for the number of (BⁱB^{o}) repetition layers and t for 1 or 0. The first layer of the barrier layer deposited on the interlayer (I) is always an inorganic layer Bⁱ, but the last layer in such stack can be either an inorganic layer (t=1) or an organic layer (t=0). The presence of such organic layers between the inorganic layers provides the barrier with additional flexibility, particularly if the MLBF has a thickness of more than 50 nm.

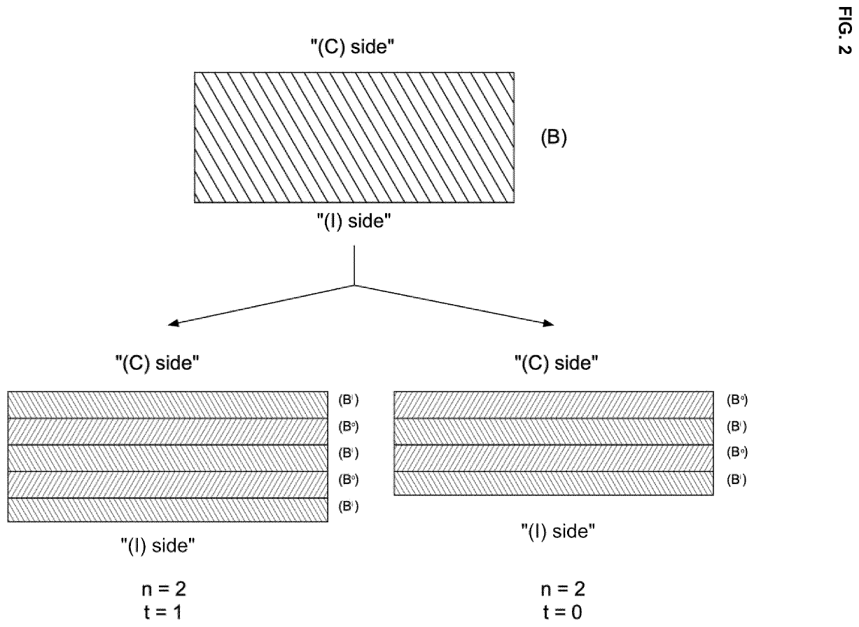

FIG. 2 shows a possible “micro-architecture” of layer (B), in case layer (B) consist of a layer stack (BⁱB^{o})ₙ(Bⁱ) t with n=2 and t=1 and 0, respectively.

The mandatory presence of the inorganic layer(s) (Bⁱ) in the at least partially inorganic barrier layer (B) is responsible for the winding ability and flexibility of the overall MLBF without the risk to compromise on water vapor transmission rate.

The deposition of the inorganic layer(s) (Bⁱ) can be achieved by several different techniques as e.g., Chemical Vapor Deposition (CVD), Physical Vapor Deposition (PVD), Atomic Layer Deposition (ALD) and/or sputtering, while the deposition of the organic layer(s) (B^{o}) can e.g., be achieved by Chemical Vapor Deposition (CVD), Molecular Layer Deposition (MLD), Organic (Thermal or Electron Beam) Evaporation, Wet Coating Deposition. Techniques like PVD, CVD and sputtering to get the inorganic layer are known to one of skill in the art and e.g., described in US 2013/0034689 A1 and EP 2 692 520 A1.

The inorganic material used to form the one or more inorganic layers is selected from the group consisting of metal oxides, metal nitrides, metal oxynitrides, and combinations thereof.

Most preferred inorganic materials to form the inorganic layer are metal oxides, particularly the metal oxides of aluminum, titanium, silicon, zinc, zirconium, hafnium, indium, tin, indium-tin, tantalum and calcium, of which aluminium, silicon and titanium, or calcium with titanium and aluminum are the preferred oxide elements. In any of the embodiments described herein, the use of metal oxides as inorganic material to form the inorganic layer(s) is particularly preferred.

It is further possible to use metal nitrides as inorganic material. Amongst the metal nitrides, the group of metal nitrides consisting of aluminum nitride, silicon nitride and boron nitride is preferred. The formation of a metal nitride layer as inorganic layer (Bⁱ) on interlayer (I) is preferably achieved by PE (Plasma Enhanced)-CVD, CVD, ALD, or sputtering. Suitable techniques are e.g., described in WO2011028119. It is shown in literature (W. Manders et al., AIMCAL R2R Conference, Florida 2017) that a thin silicon nitride barrier layer fabricated by PE-CVD on a PET substrate has a WVTR of 5*10⁻⁴ g/m²/day.

Moreover, it is possible to use metal oxynitrides as inorganic material. Amongst the metal oxynitrides, the group of metal oxynitrides consisting of aluminum oxynitride, silicon oxynitride and boron oxynitride is preferred. The formation of a metal oxynitride layer as inorganic layer (Bⁱ) on interlayer (I) is preferably achieved by PE (Plasma Enhanced)-CVD, CVD, ALD, or sputtering. Suitable techniques are e.g., described in CN 1899815 B.

Within an inorganic layer (Bⁱ), combinations of the above-mentioned inorganic material can be used. Moreover, in a stack of inorganic layers such as (Bⁱ) m each of the inorganic layers (Bⁱ) may be independently chosen from the above inorganic materials and the same applies to a layer stack such as (BⁱB^{o})ₙ(Bⁱ)ₜ, the values of m, n and t are those as described herein above.

Preferably the layer thickness of the one or more at least partially inorganic barrier layer (B) is in total in the range from 10 to 1000 nm, more preferred in the range from 20 to 500 nm and most preferred in the range from 30 to 200 nm.

Preferred, amongst the afore-mentioned techniques for deposition of the inorganic layer(s) (Bⁱ), preferably the metal oxide layers (Bⁱ) are ALD, in case (B) is (Bⁱ)ₘ; and ALD combined with MLD, in case of (B) is (BⁱB^{o})ₙ(Bⁱ)ₜ.

The use of the ALD technique for the preparation of preferably transparent barrier layer (Bⁱ) is preferred, since it is possible by using ALD to step-wise form chemically-bound nanolaminate self-limiting layers with excellent thickness control that are highly conformal, well order and dense each with a defined thickness. Such method, particularly to produce metal oxide layers (Bⁱ), is e.g., disclosed in WO 2011/099858 A1, but is also part of the combined ALD/MLD techniques as e.g., disclosed WO 2015/188990 A2 and WO 2015/188992 A1.

Even more preferred the preferably transparent barrier layer is (BⁱB^{o})ₙ(Bⁱ)ₜ, wherein the layer(s) (Bⁱ) are obtained by ALD and the layers (B^{o}) are prepared by MLD. Combining ALD with the MLD technique allows the alternating deposition at molecular level (few nanometer thick) of organic flexibilizing layers that are deposited with covalent chemical linkage to the inorganic material as e.g., disclosed in WO 2015/188990 A2 and WO 2015/188992 A1.

The organic molecules used in the MLD technique to obtain a layer (B^{o}) have special functional groups able to be chemically-bound to the inorganic layer (Bⁱ) such as thiol, disulfide, sulfide, selenol, amine, carboxylate, phosphate or phosphonate, or derivatives thereof, as e.g., described in WO 2015/030297 A1, WO 2015/188990 A2 and WO 2015/188992 A1.

Most preferred organic molecules to produce layer (B^{o}) belong to the family of aromatic thiols, as e.g., mercaptobenzoic acid, mercaptophenol, amino mercaptophenol and the like. The scope of this organic molecular layer is to give to the brittle inorganic oxide barrier the flexibility and bendability required in roll-to-roll processing, also known as web processing, reel-to-reel processing or R2R, which is a process of creating electronic devices on a roll of flexible plastic.

Some more details on the manufacture of the at least partially inorganic barrier layer(s) (B) are described herein below under the section describing the method for producing the MLBF coated substrate of the invention.

### Radiation-Cured (Meth)Acrylate Layer (C)

Like the other layers and the polymeric substrate, the radiation-cured (meth)acrylate layer (C), which is optional, is preferably a transparent layer. Most preferably this layer serves as a topcoat layer (C), i.e., is the outermost layer of the MLBF coated substrate of the invention. Thus, radiation-cured (meth)acrylate layer (C) has not only to adhere to the at least partially inorganic layer (B), but must fulfil the requirements on topcoat layers, such as being scratch resistant and weathering resistant, particularly this layer must provide an excellent thermal and heat resistance.

The term “radiation-cured” is used in the same way as above for the interlayer (I).

The radiation-cured (meth)acrylate layer(s) (C) are also preferably based on UV-cured solvent-free (meth)acrylic system, like the interlayer (I). The term “solvent-free” means free of non-reactive solvent, since reactive diluents are not excluded by this term.

Preferably, the coating material used to produce the radiation-cured (meth)acrylate layer(s) (C) has a viscosity at 25° C. determined by Capillary Viscometers or Rotational Rheometer before curing of less than 500 mPas, more preferably less than 300 mPas.

The final thickness of the radiation-cured (meth)acrylate layer (C) preferably ranges from 1 to 100 μm, more preferred from 1 to 50 μm and most preferred from 5 to 30 μm. The coating material applied to form the radiation-cured (meth)acrylate layer(s) (C) can be applied by standard wet coating methods, the same as can be used for interlayer coating materials (ICM).

Like the interlayer coating materials (ICM), the coating materials (CCM) used to produce the radiation-cured (meth)acrylate layer (C) preferably comprise the following ingredients
i. one or more radiation-curable oligomeric (meth)acrylate-functional species;
ii. one or more radiation curable (meth)acrylate-functional monomers;
iii. optionally one or more adhesion promoters;
iv. in case of UV-curing, one or more photoinitiators;
v. one or more compounds selected from UV absorbers, light stabilizers, and antioxidants; and
vi. optionally one or more coatings additives.

The ingredients i. to vi. are typically the same as for the interlayer coating material (I) with a few preferred variations as shown below.

Typically, the one or more radiation-curable oligomeric (meth)acrylate-functional species i. used in the coating materials (CCM) have a viscosity at 25° C. above 70 mPas, determined as described in the experimental part of the present invention.

The total amount of the one or more radiation-curable oligomeric (meth)acrylate-functional species i. preferably ranges from 5 wt.-% to 30 wt.-% most preferably from 5 wt.-% to 20 wt.-% and even more preferred from 5 wt.-% to 15 wt.-% based on the total weight of the radiation-curable coating material (CCM).

The one or more radiation curable (meth)acrylate-functional monomers ii. are preferably the same as described above for the interlayer coating material (I) with the exception that less or none of the hydroxy functional (meth)acrylate-functional monomers ii. as described above are used in the coating material (CCM) forming the radiation-cured (meth)acrylate layer (C). Thus, the hydroxyl number of the coating material (CCM) is preferably from 1 to 100 mg KOH/g, more preferred from 2 to 60 mg KOH/g and most preferred from 5 to 30 to mg KOH/g.

Such radiation curable (meth)acrylate-functional monomers preferably possess low viscosities, preferably viscosities at 25° C. from 1 to 50 mPas, more preferred from 2 to 40 mPas or even 2 to 30 mPas. They are used to dilute the radiation-curable oligomeric (meth)acrylate-functional species and are thus also known as radiation-curable reactive diluents, since they act as solvents, but remain in the cured coating after curing. Such monomers may, in some cases, contain dialkyleneglycol or trialkyleneglycol groups, but are still considered herein as monomers due to their definite molecular weight and viscosity below 50 mPas at 25° C.

The total amount of the one or more radiation-curable (meth)acrylate-functional monomers ii. preferably ranges from 10 wt.-% to 90 wt.-% most preferably from 15 wt.-% to 85 wt.-% and even more preferred from 20 wt.-% to 80 wt.-% based on the total weight of the radiation-curable coating material (CCM).

If adhesion promoters iii. are present, the one or more adhesion promoters are defined as for the interlayer coating material (ICM).

The total amount of the one or more adhesion promoters iii. preferably ranges from 0.5 wt.-% to 10 wt.-% most preferably from 1 wt.-% to 8 wt.-% and even more preferred from 1.5 wt.-% to 7 wt.-% based on the total weight of the radiation-curable coating material (CCM).

In case of the preferred UV-curing, one or more photoinitiators are employ, which are defined as for the interlayer coating material (ICM)

The total amount of the one or more photoinitiators iv., if contained, preferably ranges from 0.5 wt.-% to 6 wt.-% most preferably from 2 wt.-% to 5 wt.-% and even more preferred from 3 wt.-% to 4 wt.-% based on the total weight of the radiation-curable coating composition.

The UV absorbers and light stabilizers are defined as for the interlayer coating material (ICM).

The total amount of the one or more UV absorbers v. preferably ranges from 1 wt.-% to 5 wt.-%, more preferred from 1.5 to 3.5 wt.-% based on the total weight of the radiation-curable coating material (CCM). The total amount of the one or more light stabilizers v. preferably ranges from 0.2 wt.-% to 4 wt.-%, more preferred from 0.5 to 3 wt.-% and most preferred from 0.8 to 2 wt.-% based on the total weight of the radiation-curable coating material (CCM).

The antioxidants v. are preferably tert-butyl hindered phenols and serve to improve long-time weatherability and thermal resistance, properties which are particularly relevant for topcoat layers.

The total amount of the one or more antioxidants v. preferably ranges from 0.1 wt.-% to 2 wt.-%, more preferred from 0.2 to 1 wt.-% based on the total weight of the radiation-curable coating material (CCM).

The coating materials (CCM) may contain typical coatings additives, such as levelling agent, defoamers, preferably, but not necessarily are reactive in radiation-curing. The amount of coating additives is preferably in the range from 0 to 5 wt.-%, more preferred 0 to 3 wt.-% and most preferred 0 to 2 wt.-% based on the total weight of the radiation-curable interlayer coating material (ICM).

Examples of such coating materials (CCM) are found in WO 2022/233992 A1 in Examples C1 and C2.

### Method of Producing a Multilayer Barrier Film Coated Substrate

The invention provides a method for producing a multilayer barrier film coated polymeric substrate comprising the at least the steps of
a. providing a polymeric substrate (A);
b. applying an interlayer coating material (ICM) as defined above and curing the interlayer coating material (ICM) to form a cured interlayer (I),
c. depositing one or more inorganic layers on the substrate by one or more methods selected from chemical vapor deposition (CVD), physical vapor deposition (PVD), atomic layer deposition (ALD) and sputtering to form one or more, at least partially inorganic barrier layers (B); and
d. optionally applying one or more radiation-curable (meth)acrylic coating materials (CCM) on the one or more, at least partially inorganic barrier layers (B) to form one or more radiation-curable (meth)acrylate layers and curing said layer or layers to form one or more radiation-cured (meth)acrylate layers (C),
e. optionally repeating steps c. and d.; and
f. optionally applying and curing a further coating material to form a further coating layer (D).

### Step a.

The substrate used in the above method is a polymeric substrate, even more preferred a transparent, polymeric substrate selected from those as being described above. The substrate, particularly the polymeric substrate may be surface treated, typically to enhance the adhesion between the support and layers provided thereon. Examples of such a surface treatment include but are not limited to a corona discharge treatment, a flame treatment, an UV treatment, a low-pressure plasma treatment, and an atmospheric plasma treatment.

### Step b.

In step b. an interlayer coating material (ICM) is applied, which is defined as above.

These ingredients and preferred embodiments were described in detail above as well as the preferred contents of the ingredients in the interlayer coating material (ICM).

Since the interlayer coating material (ICM) should be radiation-curable to form interlayer (I), which is preferably transparent, this material should preferably be substantially free from light-absorbing piments and fillers. The same applies to the optional coating material (CCM) forming the optional radiation-cured (meth)acrylate layer (C).

Interlayer coating materials (ICM) may be applied by any suitable wet coating method. Suitable coating methods are, for example: spin-coating, blade coating, knife coating, kiss roll coating, cast coating, slot-orifice coating, calendar coating, die coating, dipping, brushing, casting with a bar, roller-coating, flow-coating, wire-coating, spray-coating, dip-coating, whirler-coating, cascade-coating, curtain-coating, air knife coating, gap coating, rotary screen, reverse roll coating, (revers) gravure coating, metering rod (Meyer bar) coating, slot die (Extrusion) coating, hot melt coating, roller coating, flexo coating. Suitable printing methods include: silk screen printing, relief printing such as flexographic printing, ink jet printing, intaglio printing such as direct gravure printing or offset gravure printing, lithographic printing such as offset printing, or stencil printing such as screen printing.

In case of the preferred UV curing, the curing wavelengths range, intensity, and energy of the UV light are chosen depending on the photosensitivity of the interlayer coating material (ICM). Typically, the wavelengths are in the UV-A, UV-B and/or UV-C range. Preferably, radiation comprises light of wavelengths less than 400 nm, more preferred of wavelengths less than 380 nm. Particularly preferred is the use a UV mercury lamps as radiation source with an UV-Vis intensity of at least 600 mJ/cm² and better of 800 mJ/cm².

### Step c.

The inorganic layer or layers are applied to the substrate by one or more methods selected from chemical vapor deposition (CVD), physical vapor deposition (PVD), atomic layer deposition (ALD) and sputtering to form one or more preferably transparent, at least partially inorganic barrier layers (B).

The afore-mentioned methods are known to one of skill in the art. The CVD method to produce such layers is e.g., described in DE4035951 C1 or in CA2562914 A1 and references therein; the PVD method to produce such layers is e.g., described in EP0645470 A1 or in U.S. Pat. No. 5,900,271 A and references therein; and the sputtering method to produce such layers is e.g., described in US 2004/0005482 A1. Further reference is made to the above paragraphs describing the inorganic materials, namely the metal oxides, metal nitrides and metal oxynitrides and the literature thereon describing suitable application methods.

It is however most preferred to produce the preferably transparent barrier layer or barrier layers by using the ALD method, if such layer are inorganic, preferably metal oxide layers only. This method is e.g., described in WO 2011/099858 A1 in detail.

If more than one inorganic layer is applied, it is possible, that between the two or more inorganic layers, e.g., applied by ALD, an organic layer containing organic molecule may be applied, e.g., applied by a molecular layer deposition technique.

The organic molecules used in the MLD technique to obtain such layer (B^{o}) have special functional groups able to be chemically-bound to the inorganic layer (Bⁱ), preferably the metal oxide layer (Bⁱ) such as thiol, disulfide, sulfide, selenol, amine, carboxylate, phosphate or phosphonate, or derivatives thereof.

Most preferred organic molecules to produce layer (B^{o}) belong to the family of aromatic thiols, as e.g., mercaptobenzoic acid, mercaptophenol, amino mercaptophenol and the like.

Such partially inorganic barrier layer (B) is obtained in step c. in that subsequent to depositing a first inorganic layers (Bⁱ) an organic layer (B^{o}) is deposited by molecular layer deposition (MLD) on the inorganic layer (Bⁱ), and the deposition of both layers is repeated until a layer thickness in the range from 10 to 1000 nm is obtained and the last layer is an inorganic layer (Bⁱ) or an organic layer (B^{o}), thus forming a partially inorganic barrier layer (B).

The application of such layers by MLD is e.g., described in WO 2015/030297 A1, WO 2015/188990 A2 and WO 2015/188992 A1 to which it is referred herewith.

### Optional Step d.

Step d. can be carried out in the same ways as described for step b., however, making use of the radiation-curable (meth)acrylic coating materials (CCM).

### Optional “Step e.”

To enhance the barrier function of the MLBF coated substrate it is possible to repeat steps c. and d. one or more times.

### Optional Step f.

Although the radiation-cured (meth)acrylate layer (C), is preferably the outermost coating layer, i.e., the top coat layer, the present invention does not exclude the application of one or more further layers, which is however not preferred. Such coating layer(s) might be thermally-cured, i.e., cured by a mechanism, where no radiation is involved and were a binder carrying reactive functional groups and a separate crosslinking agent carrying functional groups that are reactive towards the functional groups of the binder are involved in the curing mechanism. Such layers (D) can be the ones as described in WO 2022/233992 A1 as thermally-cured layer(s) (D).

### Use of the Multilayer Barrier Films and MLBF Coated Substrates

Such MLBF coated substrates can be used in electronic devices, including optoelectronic devices, e.g., as protective sheets in photovoltaic applications. Such protective sheets can preferably be used in applications like solar cell modules as front protective sheet (frontsheet) or back protective sheet (backsheet) due to their lower weight, flexibility, and advantageous costs; other possible applications are portable lighting devices, advance packaging for electronics including optoelectronics and displays like for example OLED screens.

### EXAMPLES

In the following the invention is described by means of Examples. If not stated otherwise, parts are all parts-by-weight and percentage values in relation of ingredients of compositions are in weight percent.

### Testing Procedures

### Testing of the Interlayer Coating Material (ICM)

### Hydroxyl Number (OH Number)

The hydroxyl number was determined by acetylation of free hydroxyl groups with acetic anhydride and subsequent titration of the excess of the acid using a Mettler Toledo Titrator Compact V20.

### Viscosity

The viscosity was determined at 25° C. or 50° C. with a Brookfield CAP2000+ viscometer 10 min after mixing at 100 rpm (spindle: conical disc-like code 1014 01).

### Testing of the Multilayer (Barrier) Films

Multilayer (barrier) films have been kept for at least 24 h in closed brown glass bottles under air at a temperature of 23±2° C. with no control of humidity.

### Tape Cross-Cut Adhesion

Tape cross-cut adhesion was determined according to ASTM D3359-17 (6 blades at 2 mm distance; before (0 h) and after (168 h) climate aging (at 85° C. and 85% relative humidity); tape: Tesakrepp® 4331).

### Dynamic Mechanical Analysis (DMA)

DMA was carried out using a Waters TA Instrument Discovery DMA 850 (frequency: 1 Hz, single; heating: equilibrating at 10° C.; isothermal 5 min at 10° C.; heating rump: 5° C./min. method: multi frequency strain).

The Following Parameters were Determined:
(a) Storage Modulus at 20° C.
(b) Glass Transition Temperature.

### Layer Thickness of the Coating Layers

The layer thickness was determined on the dry or where cured layers (P), (B), (C) and (D) by using a non-destructive dry-film measurement using for example a Coating Thickness Gauge like Byko-Test 4200 (available from BYK Instruments).

### Moisture Permeation (WVTR) Test

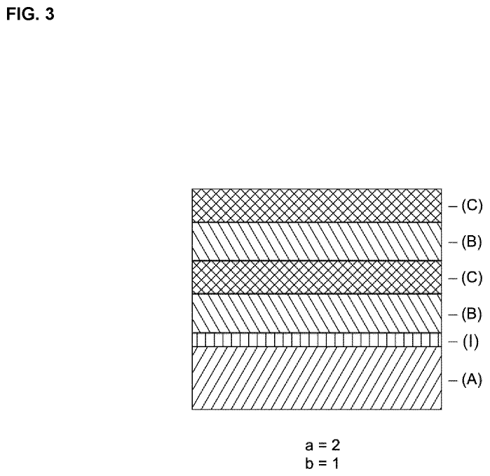

Moisture Permeation (WVTR) has been optically evaluated by measuring the degradation of a layer of metallic calcium that is deposited on a glass substrate, and which reacts with moisture/water under formation of transparent nonconductive calcium hydroxide and hydrogen over time. The polymeric film (A) supported multilayer barrier film (interlayer (I) plus partially inorganic barrier layer (B)) acts as what is called “Barrier film” in the cell as shown in FIG. 3 of the following scientific article: Organic Electronic, 2014, 15, pages 3746-3755. The WVTR test was performed at 60° C. (90% relative humidity).

A description of the WVTR test method and the apparatus are described in detail in US2006/0147346A1 and Organic Electronic, 2014, 15, pages 3746-3755.

FIG. 3 of the latter scientific article shows a schematic view of a calcium test cell and illustration of residual permeation paths into the cell (black arrows): The calcium thin film (“sensor”) is encapsulated by two barrier films on top and bottom (substrate, generally glass) plus an adhesive perimeter seal. The sensor measures the combined permeation rates of all these barriers plus additional water vapor entry via interfacial permeation. The cavity is nitrogen filled.

### WORKING EXAMPLES

### Polymeric Film/Substrate (A)

As a polymeric substrate, a polyester optical film (PET; polyethylene terephthalate; film thickness 125 μm; SKYROL® V7610 polyester film commercially available from Curbell Plastics) was used.

### Interlayer Coating Material (ICM)

### Example 1

In a 200 ml dark brown four neck round bottom flask equipped with a magnetic stirrer, thermocouple, and condenser 67.1 ml of glycerol dimethacrylate (328.66 mmol; 75 g), 13.74 ml (46.19 mmol; 16 g) of 1,4-butanediylbis[oxy(2-hydroxy-3,1-propanediyl)]diacrylate and 5 g of aliphatic polyurethane acrylate resin Laromer® UA9033 ((meth)acrylic group functionalized urethan (meth)acrylate oligomer; Mw: circa 1230 g/mol, OH number: circa 6 mg KOH/g) are added sequentially at room temperature under nitrogen and continuous stirring. To this mixture 1.0 ml (1.32 mmol, 1 g) of Tinuvin® 292 followed by 3 g (7.17 mmol) of Phenylbis(2,4,6-trimethylbenzoyl) phosphine oxide are also added.

The resulting mixture is left stirring under nitrogen overnight, filtered with a 1 μm plastic filter and then coated with a bar coater metal blade at 20 mm/min on the 125-μm-PET-film (SKYROL® V7610 polyester film) under nitrogen and then cured with a Hg—UV lamp. The final coating has a thickness as shown in Table 2.

The properties of the interlayer coating material (ICM) and cured interlayer films (I) are shown in Table 1 and 2.

### Example 2 to 8

The interlayer coating materials (ICM) of Examples 2 to 8 and interlayers (I) produced thereof are prepared in analogy to Example 1. The relevant amounts and data for Examples 2 to 8 are shown in Table 1 and 2. Examples 7 and 8 are referring to interlayer coating materials (CM) with hydroxyl numbers (OH numbers) outside of the range of 50 to 250 mg KOH/g), respectively 31 and 254 mg KOH/g.

### Preparation of a Partially Inorganic Barrier Layer (B)

The ALD deposition process on the interlayer (I) coated polymeric film (A) was done on a roll-to-roll line equipped with a reactor with cylindrical shape and a diameter of 600 mm (active length of 611 mm) which is divided into 20 segments (each segment with a length of circa 94 mm). Each segment has a dosing section, an exhaust section and a curtain section of an inert gas that separates the gases between the different segments to avoid contamination. A mixture of three different gases was used for the deposition and film functionalization process: Tri-methyl aluminum (TMA), evaporated water (H₂O) and an organic precursor (4-mercaptophenol), each precursor was dosed from different segments in the cylinder. The pressure at which the different gases were dosed was approximately 300 mbar and the temperature was in the range of 110 to 120° C.

For the deposition, the polymeric film (A), which was coated with the cured interlayer (I) moved around the reactor at a speed of 1 to 2 m/min while the cylinder rotated with surface speed contrary to the velocity of the web. The substrate and the reactor never came in direct contact.

When the interlayer (I) coated polymeric film (A) was in the segment reaction volume, a monolayer of a precursor was deposited. By adjusting the web and/or the drum speed including the segment/precursor combination, a heterogeneous partially inorganic barrier layer structure composed of AlOₓ and the organic precursor was deposited on the film substrate.

The thus prepared partially inorganic barrier layer had an overall thickness in the range of 40 to 50 nm. This thickness was adjusted to have optimal WVTR barrier property and to avoid cracks formation during film handling.

### Results

As shown in Table 2, in examples 1 to 6, all inside the range of 50 to 250 mg KOH/g, the adhesion after the tape cross-cut adhesion testing for both assembly substrate and interlayer (A/I) and assembly substrate, interlayer, barrier layer and top coat layer (A/I/B/C), is excellent at “hour 0” and even after 168 hours of climate aging it is excellent for 3 of 6 examples and very good for the other 3 examples. This is particularly good, since in practice the cured interlayer is not directly exposed to weathering, but only the subsequent layers, particularly the outermost layer.

The storage modulus is in the most preferred range for all examples and the glass transition temperature high enough to withstand any undesired softening at typical temperature ranges in practice.

Furthermore, the WVTR remains to be in the desired ranges.

For example 7 with an hydroxyl number below 50 mg KOH/g the adhesion after the tape cross-cut adhesion testing for assembly A/I/B/C is not acceptable already at “hour 0”.

For example 8 with an hydroxyl number above 250 mg KOH/g the adhesion after the tape cross-cut adhesion testing for assembly A/I/B/C is not acceptable after 168 hours of climate aging. The storage modulus and the glass transition temperature are not measurable due to the extremely high brittleness of the layer.

Furthermore, the WVTR for both comparative examples 7 and 8 is larger than the desired range.

TABLE 1
Ingredients and Properties of Interlayer Coating Material (ICM)

| Interlayer Coating Material | Examples | | | | | | | |
|---|---|---|---|---|---|---|---|---|
| (ICM) | 1 | 2 | 3 | 4 | 5 | 6 | 7** | 8** |
| Ingredients of (ICM) | | | | | | | | |
| (amounts in g) | | | | | | | | |
| glycerol dimethacrylate | 75 | 24 | 30 | 24 | 44 | 61 | 0 | 61 |
| 1,4-butanediylbis[oxy(2- | 16 | — | — | — | — | 30 | — | 16 |
| hydroxy-3,1-propanediyl)] | | | | | | | | |
| diacrylate | | | | | | | | |
| 3-methacryloxypropyl- | — | 5 | 5 | 5 | 5 | — | — | — |
| trimethoxysilane | | | | | | | | |
| 1,6-hexanediol diacrylate | | | | | | | 17 | — |
| tricyclodecanedimethanol | | | | | | | 75 | — |
| diacrylate | | | | | | | | |
| 2-hydroxyethylacrylat | | | | | | | — | 14 |
| Ebecryl ® 767* | — | 10 | 10 | 10 | 10 | — | — | — |
| trimethylolpropane formal | — | 24 | 23 | 45 | 25 | — | — | — |
| acrylate | | | | | | | | |
| tricyclodecanemethanol | — | 21 | 16 | — | — | — | — | — |
| acrylate | | | | | | | | |
| Laromer ® UA9033 (mmol) | 5 | 12 | 12 | 12 | 12 | 5 | 5 | 5 |
| Tinuvin ® 292 | 1 | 1 | 1 | 1 | 1 | 1 | — | 1 |
| phenylbis(2,4,6- | 3 | 3 | 3 | 3 | 3 | 3 | 3 | 3 |
| trimethylbenzoyl) phosphine | | | | | | | | |
| oxide | | | | | | | | |
| Sum | 100 | 100 | 100 | 100 | 100 | 100 | 100 | 100 |
| Properties of (ICM) | | | | | | | | |
| viscosity at 25° C. (mPas) | 133 | 123 | 127 | 118 | 153 | 198 | 86 | 72 |
| viscosity at 50° C. (mPas) | 31 | 40 | 39 | 37 | 44 | 42 | 25 | 20 |
| hydroxyl number (mg KOH/g) | 221 | 68 | 83 | 71 | 116 | 227 | 31 | 254 |

*mixture of carboxylic acid functional (meth)acrylic-functionalized poly(meth)acrylate (70 wt.-%), with isobornyl acrylate (28 wt.-%) and trimethylolpropane triacrylate (2 wt.-%)
**comparative examples

TABLE 2
Properties of the Cured Interlayer (I)

| | | Examples | | | | | | | |
|---|---|---|---|---|---|---|---|---|---|
| Cured Interlayer (I) | | 1 | 2 | 3 | 4 | 5 | 6 | 7** | 8** |
| Properties of (I) | | | | | | | | | |
| A/I Tape | 0 hours (%) | 100 | 100 | 100 | 100 | 100 | 100 | 100 | 100 |
| Cross-Cut | 168 hours (%) | 100 | >95 | 100 | 100 | >85 | >90 | 90 | 95 |
| Adhesion | | | | | | | | | |
| A/I/B/C | 0 hours (%) | 100 | 90 | 100 | 100 | 100 | 100 | 0 | 100 |
| Tape | 168 hours (%) | 60 | 70 | 95 | 75 | 55 | 50 | 0 | 0 |
| Cross-Cut | | | | | | | | | |
| Adhesion | | | | | | | | | |
| Dynamic | storage | 2017 | 1662 | 1610 | 1939 | 2090 | 1646 | 2871 | NA* |
| Mechanical | modulus | | | | | | | | |
| Analysis | (MPa) at 20° C. | | | | | | | | |
| | glass transition | 95 | 100 | 120 | 104 | 115 | 145 | 134 | NA* |
| | temperature | | | | | | | | |
| | (° C.) | | | | | | | | |

| Interlayer (I) Thickness | 8.5 ± 1.5 |
|---|---|
| (μm) | |

Cured Interlayer (I) plus
Barrier Layer (B)

| WVTR (g/m²/day) | 1.3 × | 1.8 × | 1.4 × | 1.6 × | 1.3 × | 2.6 × | 3.6 × | 5.1 × |
|---|---|---|---|---|---|---|---|---|
| [hours] | 10⁻³ | 10⁻³ | 10⁻³ | 10⁻³ | 10⁻³ | 10⁻³ | 10⁻³ | 10⁻³ |
| | [165] | [165] | [165] | [145] | [165] | [145] | [100] | [140] |

*NA = not applicable; measurement not possible due to high brittleness of sample
**comparative examples

1. A multilayer barrier film coated polymeric substrate (A), the multilayer barrier film at least comprising
a radiation-cured interlayer (I) on top of the polymeric substrate (A), and one or more at least partially inorganic barrier layers (B) on top of the interlayer (I),
the interlayer (I) being formed upon application and radiation-curing of a radiation-curable interlayer coating material (ICM) on the polymeric substrate, wherein
the radiation-curable interlayer coating material (ICM) possesses a hydroxyl number in a range from 50 to 250 mg KOH/g.

2. The multilayer barrier film coated polymeric substrate (A) according to claim 1,
wherein the polymeric substrate is selected from the group consisting of polyesters, polyimides, polyacrylates, polyacrylamides, polycarbonates, polyvinylalcohols, polyvinylchlorides; polyolefins, polysulfones, polyamides, cellulose derivatives, polyurethanes, epoxy resins, melamine formaldehyde resins and phenol formaldehyde resins.

3. The multilayer barrier film coated polymeric substrate (A) according to claim 1, wherein the radiation-curable interlayer coating material (ICM) comprise
i. one or more radiation-curable oligomeric (meth)acrylate-functional species;
ii. one or more radiation curable (meth)acrylate-functional monomers;
iii. optionally one or more adhesion promoters;
iv. in case of UV-curing, one or more photoinitiators;
v. one or more compounds selected from the group consisting of UV absorbers and light stabilizers; and
vi. optionally one or more coatings additives.

4. The multilayer barrier film coated polymeric substrate (A) according to claim 3, wherein the
i. one or more radiation-curable oligomeric (meth)acrylate-functional species are selected from the group consisting of polyester (meth)acrylates, epoxy (meth)acrylates, aliphatic and/or aromatic urethane (meth)acrylates, aliphatic urethane (meth)acrylates, polyether (meth)acrylates and (meth)acrylated poly(meth)acrylates;
ii. one or more radiation curable (meth)acrylate-functional monomers are selected from the group consisting of mono(meth)acrylate-functional monomers, di(meth)acrylate-functional monomers and tri(meth)acrylate-functional monomers, at least part of the (meth)acrylate-functional monomers having one or more hydroxyl groups;
iii. the one or more optional adhesion promoters are selected from the group consisting of functionalized trialkoxysilanes and functionalized dialkoxyalkylsilanes, being functionalized with a group selected from thiol groups, (meth)acryl groups, amino groups and epoxy groups; and
(meth)acrylated phosphoric acid esters;
iv. one or more photoinitiators;
v. the one or more light stabilizers being selected from the group consisting of hindered amine light stabilizers and NOR-HALS; and
vi. optionally one or more coatings additives.

5. The multilayer barrier film coated polymeric substrate (A) according to claim 4, wherein the
i. one or more radiation-curable oligomeric (meth)acrylate-functional species are selected from the group consisting of aliphatic and/or aromatic urethane (meth)acrylates, and (meth)acrylated poly(meth)acrylates;
ii. one or more radiation curable di(meth)acrylate-functional monomers contain one or more hydroxyl groups, preferably one hydroxyl group;
iii. one or more optional adhesion promoters are selected from the group consisting of (meth)acrylic trialkoxysilanes (meth)acrylic dialkoxyalkylsilanes; and
(meth)acrylated phosphoric acid esters;
iv. one or more photoinitiators are selected from the group consisting of alpha-cleaving photoinitiators; and
v. one or more compounds are selected from UV absorbers, which are selected from the group consisting of 2-(2′-hydroxyphenyl)benzotriazoles, 2-hydroxybenzophenones, esters of substituted and unsubstituted benzoic acids, acrylates, 2-(2-hydroxyphenyl)-1,3,5-triazines and oxamides; and one or more light stabilizers selected from the group consisting of hindered amine light stabilizers and NOR-HALS.

6. The multilayer barrier film coated polymeric substrate (A) according to claim 4, wherein the
ii. one or more radiation curable mono(meth)acrylate-functional monomers, comprise cyclic hydrocarbyl esters of (meth)acrylic acid and ether oxygen containing cyclic hydrocarbyl esters of (meth)acrylic acid; and one or more di(meth)acrylate-functional, hydroxyl group containing monomers; and
v. one or more light stabilizers are selected from the group consisting of hindered amine light stabilizers and NOR-HALS.

7. The multilayer barrier film coated polymeric substrate (A) according to claim 3, wherein the
ii. one or more radiation curable mono(meth)acrylate-functional monomers comprise at least one of the mono(meth)acrylates and di(meth)arylates of glycerol, trimethylol propane and trimethylol ethane; the mono(meth)acrylates, di(meth)acylates and tri(meth)acrylates of pentaerythritol, ditrimethylolpropane, and ditrimethylolethane; and the alpha, omegy-alkanediylbis[oxy(2-hydroxy-3,1-propanediyl)]di(meth)acrylates.

8. The multilayer barrier film coated polymeric substrate (A) according to claim 3, wherein
ii. one or more radiation curable mono(meth)acrylate-functional monomers comprise at least one of glycerol di(meth)acrylate and 1,4-butanediylbis[oxy(2-hydroxy-3,1-propanediyl)]di(meth)acrylate.

9. The multilayer barrier film coated polymeric substrate (A) according to claim 3, wherein the ingredients listed under i. to vi. are contained in amounts of the following ranges
i. 1 to 30 wt.-%,
ii. 65 to 95 wt.-%,
iii. 0 to 10 wt.-%,
iv. 0.5 to 6 wt.-%,
v. 0 to 8 wt.-% UV absorbers; and 0 to 6 wt.-% light stabilizers, and
vi. 0 to 5 wt.-%.

10. The multilayer barrier film coated polymeric substrate (A) according to claim 1, wherein
the at least partially inorganic barrier layer (B) is
(1) an inorganic layer (Bⁱ) formed by atomic layer deposition and consisting of one or more inorganic materials selected from the group consisting of metal oxides, metal nitrides, and metal oxynitrides and combinations thereof; or
(2) a partially inorganic barrier layer (B) consists of a layer stack (BⁱB^{o})ₙ(Bⁱ)ₜ, wherein Bⁱ is an inorganic layer consisting of one or more inorganic materials selected from the group consisting of metal oxides, metal nitrides, and metal oxynitrides and combinations thereof, and B^{o} is an organic layer formed by molecular layer deposition, n is in a range of from 1 to 100 and t is 0 or 1, and the first of the n Bⁱ layers is formed directly on the radiation-cured interlayer (I).

11. The multilayer barrier film coated polymeric substrate (A) according to claim 1, wherein
it further comprises one or more radiation-cured (meth)acrylate layers (C) on top of the at least partially inorganic barrier layer (B).

12. The multilayer barrier film coated polymeric substrate (A) according to claim 1, wherein
the polymeric substrate (A) has a thickness in a range from 10 to 500 μm;
the radiation-cured interlayer (I) has a thickness in a range from 1 to 20 μm;
the at least partially inorganic barrier layer (B) has a thickness in a range from 10 to 1000 nm;
a radiation-cured (meth)acrylate layer (C) has a thickness in a range from 1 to 100 μm; and
the at least partially inorganic barrier layer (B) and radiation-cured (meth)acrylate layer (C) may form an alternating layer stack of at least partially inorganic barrier layers (B) and radiation-cured (meth)acrylate layers (C), the first at least partially inorganic barrier layers (B) being in direct contact with the radiation-cured interlayer (I).

13. A method for producing a multilayer barrier film coated polymeric substrate (A) of claim 3, comprising the steps of
a. providing a polymeric substrate (A);
b. applying the radiation-curable interlayer coating material (ICM) and curing the radiation-curable interlayer coating material (ICM) to form a radiation cured interlayer (I), and
c. depositing one or more inorganic layers (Bⁱ) on the substrate by one or more methods selected from the group consisting of chemical vapor deposition (CVD), physical vapor deposition (PVD), atomic layer deposition (ALD) and sputtering to form one or more at least partially inorganic barrier layers (B).

14. The method for producing a multilayer barrier film coated polymeric substrate (A) according to claim 13, wherein the method further comprises, subsequently to step c., the following steps
d. applying one or more radiation-curable (meth)acrylic coating materials (CCM) on the one or more, at least partially inorganic barrier layers (B) to form one or more radiation-curable (meth)acrylate layers and curing said layer or layers to form one or more radiation-cured (meth)acrylate layers (C),
e. optionally repeating steps c. and d.; and
f. optionally applying and curing a further coating material to form a further coating layer (D).

15. The method for producing a multilayer barrier film coated polymeric substrate (A) according to claim 13, wherein in step c. subsequent to depositing a first inorganic layers (Bⁱ) an organic layer (B^{o}) is deposited by molecular layer deposition (MLD) on the inorganic layer (Bⁱ), and the deposition of both layers is repeated until a layer thickness in a range from 10 to 1000 nm is obtained and the last layer is an inorganic layer (Bⁱ) or an organic layer (B^{o}), thus forming a partially inorganic barrier layer (B).

16. A method of using the multilayer barrier film coated substrate of claim 1, the method comprising using the multilayer barrier film coated substrate in electronic devices.

17. A method of using the multilayer barrier film coated substrate obtained by the method of claim 14, the method comprising using the multilayer barrier film coated substrate in electronic devices.

18. The multilayer barrier film coated polymeric substrate (A) according to claim 4, wherein in step (ii) the one or more radiation curable di(meth)acrylate-functional monomers contain one hydroxyl group.

19. The multilayer barrier film coated polymeric substrate (A) according to claim 4, wherein in step (iv) the photoinitiators are selected from the group consisting of alpha-hydroxyketones, alpha-alkoxyketones, alpha-aminoketones and acyl phosphine oxides.

20. The multilayer barrier film coated polymeric substrate (A) according to claim 4, wherein in step (v) the one or more compounds are selected from UV absorbers, which are selected from the group consisting of 2-(2′-hydroxyphenyl)benzotriazoles, 2-hydroxybenzophenones, esters of substituted and unsubstituted benzoic acids, ethyl alpha-cyano-beta, beta-diphenylacrylates, 2-(2-hydroxyphenyl)-1,3,5-triazines and oxamides; and
one or more light stabilizers selected from the group consisting of hindered amine light stabilizers and NOR-HALS.
